(19) United States
(12) Patent Application Publication
(10) Pub. No.: US 2022/0417903 A1
(43) Pub. Date: Dec. 29, 2022

(54) PAGING METHOD AND APPARATUS, COMMUNICATION DEVICE AND STORAGE MEDIUM

(71) Applicant: BEIJING XIAOMI MOBILE SOFTWARE CO., LTD, Beijing (CN)

(72) Inventor: Yang LIU, Beijing (CN)

(73) Assignee: BEIJING XIAOMI MOBILE SOFTWARE CO., LTD, Beijing (CN)

(21) Appl. No.: 17/787,586

(22) PCT Filed: Dec. 20, 2019
(86) PCT No.: PCT/CN2019/127151

§ 371 Date: Jun. 20, 2022

(51) Int. Cl. H04W 68/12

(52) U.S. Cl. CPC H04W 68/12; H04W 88/04

(57) ABSTRACT

The present disclosure relates to a paging method and apparatus, a communication device and a storage medium. The method includes: acquiring, by a first communication device, a paging message sent by a first-type network to a second communication device; and sending the paging message to the second communication device by means of a second-type network.

### CROSS-REFERENCE TO RELATED APPLICATION

The present application is a U.S. National Stage of International Application No. PCT/CN2019/127151, filed on Dec. 20, 2019, the entire content of which is incorporated herein by reference for all purposes.

### TECHNICAL FIELD

The present disclosure relates to, but is not limited to, the field of wireless communication technologies, and in particular to a paging method and apparatus, a communication device and a storage medium.

### BACKGROUND

At present, wearable devices such as smart watches or sports bracelets have implemented communication using cellular mobile communication technologies.

With the introduction of the 5th Generation (5G) cellular mobile communication technologies, a base station may adopt beamforming technologies to send signals.

### SUMMARY

The present disclosure provide a paging method and apparatus, a communication device, and a storage medium.

According to a first aspect of the present disclosure, there is provided a paging method, applied to a first communication device, and the method includes:

acquiring a paging message sent by a first-type network to a second communication device; and

sending the paging message to the second communication device through a second-type network.

According to a second aspect of the present disclosure, there is provided a paging method, applied to a second communication device, and the method includes:

receiving a paging message sent by a first communication device using a second-type network, wherein the paging message is sent from a first-type network to the second communication device.

According to a third aspect of the present disclosure, there is provided a paging method, applied to a core network of a first-type network, and the method includes:

sending a paging message of a second communication device to a first communication device through the first-type network.

It should be noted that the above general description and the following detailed description are merely exemplary and explanatory and should not be construed as limiting of the examples of the present disclosure.

### BRIEF DESCRIPTION OF THE DRAWINGS

The accompanying drawings, which are incorporated in and constitute a part of the disclosure, illustrate examples consistent with the present disclosure and, together with the description, serve to explain principles of the examples of the present disclosure.

FIG. 1 is a schematic structural diagram showing a wireless communication system according to an example of the present disclosure;

FIG. 2 is a schematic flowchart showing a paging method according to an example of the present disclosure;

FIG. 3 is a schematic flowchart showing another paging method according to an example of the present disclosure;

FIG. 4 is a schematic flowchart showing yet another paging method according to an example of the present disclosure;

FIG. 5 is a schematic flowchart showing still another paging method according to an example of the present disclosure;

FIG. 6 is a schematic flowchart showing still another paging method according to an example of the present disclosure;

FIG. 7a is a schematic diagram showing a communication architecture according to an example of the present disclosure;

FIG. 7b is a schematic diagram showing another communication architecture according to an example of the present disclosure;

FIG. 7c is a schematic diagram showing yet another communication architecture according to an example of the present disclosure;

FIG. 8 is a schematic diagram showing information interaction according to an example of the present disclosure;

FIG. 9 is a block diagram showing a paging apparatus according to an example of the present disclosure;

FIG. 10 is a block diagram showing another paging apparatus according to an example of the present disclosure;

FIG. 11 is a block diagram showing yet another paging apparatus according to an example of the present disclosure; and

FIG. 12 is a block diagram showing a device for paging according to an example of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the embodiments of the present disclosure and the appended claims, the singular forms “a”, “the” and “said” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, first information may also be referred to as second information, and similarly, the second information may also be referred to as the first information. Depending on the context, the word “if” as used herein can be interpreted as “upon” or “when” or “in response to determination”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

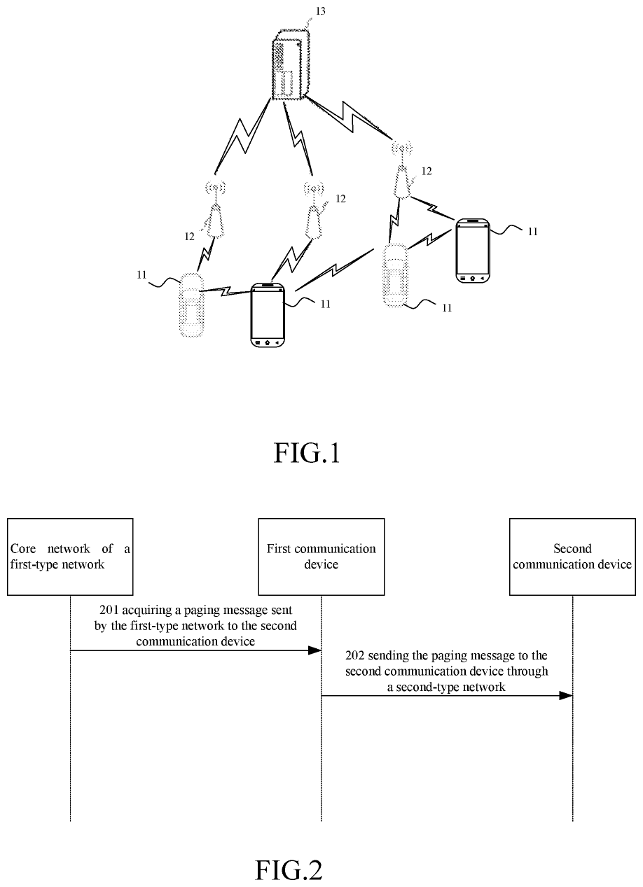

Reference is made to FIG. 1, which shows a schematic structural diagram of a wireless communication system according to an example of the present disclosure. As illustrated in FIG. 1, the wireless communication system is a communication system based on cellular mobile communication technologies. The wireless communication system may include several terminals 11 and several base stations 12.

The terminal 11 may refer to a device that provides voice and/or data connectivity to a user. The terminal 11 may communicate with one or more core networks via a radio access network (RAN). The terminal 11 can be an Internet of Things terminal, such as a sensor device, a mobile phone (or a “cellular” phone) and a computer with the Internet of Things terminal. The terminal may be, for example, a fixed, portable, pocket-sized, handheld, built-in computer or vehicle-mounted device, such as a station (STA), a subscriber unit, a subscriber station, a mobile station, a mobile, a remote station, an access point, a remote terminal, an access terminal, a user terminal, a user agent, a user device, or a user equipment (UE). Or, the terminal 11 may also be a device of an unmanned aerial vehicle. Or, the terminal 11 may also be a vehicle-mounted device, such as a trip computer with a wireless communication function, or a wireless communication device connected to an external trip computer. Or, the terminal 11 may also be a roadside device, such as a streetlight, a signal light or another roadside device with a wireless communication function.

The base station 12 can be a network-side device in a wireless communication system. The wireless communication system can be a 4th generation mobile communication (4G) system, also known as a long-term evolution (LTE) system. Or, the wireless communication system may also be a 5G system, also known as a new radio (NR) system or a 5G NR system. Or, the wireless communication system may also be a next-generation system of 5G system. An access network in the 5G system can be referred to as a new generation-radio access network (NG-RAN) or a MTC system.

The base station 12 can be an evolved NodeB (eNB) in the 4G system. Or, the base station 12 may also be a gNB with a central distributed architecture in the 5G system. When the base station 12 adopts the central distributed architecture, it usually includes a central unit (CU) and at least two distributed units (DUs). The CU is provided with a protocol stack of a packet data convergence protocol (PDCP) layer, a radio link control (RLC) layer, and a media access control (MAC) layer. The DU is provided with a protocol stack of a physical (PHY) layer. A specific implementation of the base station 12 is not limited in the examples of the present disclosure.

A wireless connection can be established between the base station 12 and the terminal 11 through a radio air interface. In different implementations, the radio air interface is a radio air interface based on a 4th generation mobile cellar communication network technology (4G) standard. Or, the radio air interface is a radio air interface based on a 5th generation mobile cellar communication network technology (5G) standard, such as an NR. Or, the radio air interface may also be a radio air interface based on a 5G next-generation mobile cellar communication network technology standard.

In some examples, an end to end (E2E) connection may also be established between the terminals 11, such as a vehicle to vehicle (V2V) communication, a vehicle to infrastructure (V2I) communication and a vehicle to pedestrian (V2P) communication in a vehicle to everything (V2X) communication, and other scenarios.

In some examples, the above wireless communication system may further include a network management device 13.

The several base stations 12 are connected to the network management device 13, respectively. The network management device 13 can be a core network device in the wireless communication system. For example, the network management device 13 can be a mobility management entity (MME) in an evolved packet core (EPC) network. Or, the network management device may also be another core network device, such as a serving gateway (SGW), a public data network gateway (PGW), a policy and charging rules function (PCRF) unit or a home subscriber server (HSS). An implementation form of the network management device 13 is not limited in the examples of the present disclosure.

Executive bodies involved in the examples of the present disclosure include, but are not limited to: wearable devices, user equipment such as terminals in a mobile cellular communication network, and base stations.

Application scenarios of the examples of the present disclosure include, but are not limited to, a scenario in which a user often carries both a wearable device, such as a smart watch, a sports bracelet, or smart clothing, and a mobile phone, and the wearable device is usually connected with the mobile phone by Bluetooth communication. From a perspective of a base station, the wearable device and the mobile phone are always in one location of one cell. However, when performing paging, the base station needs to send paging messages to the wearable device and the mobile phone, respectively; if the mobile phone of the user is connected with multiple wearable devices, the base station needs to send the paging messages to the mobile phone and the multiple wearable devices, respectively. A battery capacity of the wearable device is small, and from the perspective of the wearable device, there is waste in both power consumption and a wireless resource.

Furthermore, after 5G evolves to a high frequency band of millimeter waves, the wearable device frequently listens to the paging message, which may greatly consume the power of the wearable device.

As shown in FIG. 2, the examples of the present disclosure provide a paging method, which is applied to a first communication device. The paging method includes:

in step 201, a paging message sent by a first-type network to a second communication device is acquired; and

in step 202, the paging message is sent to the second communication device through a second-type network.

The first communication device may be a communication device with a larger battery capacity or a larger amount of remaining power. The second communication device may be a communication device with a smaller battery capacity or a less amount of remaining power.

In some examples of the present disclosure, the first communication device may be a mobile phone or the like with a larger amount of power. The second communication device may be a wearable device such as a smart watch, a sports bracelet, or the like, or the mobile phone with less remaining power.

The first-type network and the second-type network may be networks with different communication protocols, different communication frequency bands, and/or different power ranges.

The first-type network may be a wireless communication network with a larger coverage, and a wireless signal of the first-type network has a larger transmit power.

The second-type network may be a wireless communication network with a smaller coverage, and a wireless signal of the second-type network has a smaller transmit power.

In some examples of the present disclosure, the first-type network may be a cellular mobile communication network such as 4G or 5G. The second-type network may be a short range communication network such as a BlueTooth (BT) network, a low-power consumption BT network, or a Wireless Fidelity (Wi-Fi) network.

Both the first communication device and the second communication device may have capabilities of accessing the first-type network and the second-type network. Both the first communication device and the second communication device can access the first-type network, and the first communication device and the second communication device are connected through the second-type network. In some examples of the present disclosure, the smart watch and the mobile phone can access the 4G cellular mobile communication network, and the smart watch and the mobile phone are connected through the low-power consumption Bluetooth.

The second communication device may be a device in an idle state or a non-active state in the first-type network. When the second communication device is in the idle state or the non-active state, a core network or an access network of the first-type network can wake up (activate) the second communication device by sending the paging message or the like. The base station may send the paging message to the second communication device to instruct the second communication device to initiate a connection with the base station and perform communication. The paging message may include configuration information used by the second communication device to access the first-type network, and the like. The configuration information may include: paging area information, paging reason information, active information, and the like.

Continuously monitoring the paging message by the second communication device will consume power and affect the standby time of the second communication device. The wearable device such as the smart watch, the bracelet and the like carries the relatively small battery capacity due to volume limitations, and the continuous monitoring of the paging messages has a greater impact on the standby time of the wearable device.

Here, a network end of the first-type network may send the paging message intended to be sent to the second communication device to the first communication device. The second communication device no longer monitors the paging message sent by the network end of the first-type network. The paging message sent by the network end of the first-type network to the second communication device is monitored by the first communication device.

After monitoring the paging message sent by the network end of the first-type network to the second communication device, the first communication device can send the paging message to the second communication device through the second-type network. The power consumption of the second-type network between the first communication device and the second communication device is lower than the power consumption of the second communication device monitoring the paging information. Therefore, the power consumed by the second communication device due to the measurement of the wireless signal can be reduced.

In some examples of the present disclosure, the mobile phone and the smart watch are taken as an example. The mobile phone and the smart watch are connected to the base station through a cellular mobile network, and the mobile phone and the smart watch are connected through Bluetooth. When the smart watch is in the idle state or the non-active state in the cellular mobile network, the mobile phone monitors the paging message for the smart watch. When the base station sends the paging message for the smart watch, the mobile phone monitors the paging message for the smart watch, and sends the received paging message intended to be sent to the smart watch, to the smart watch through the Bluetooth connection. The power consumption of the Bluetooth connection between the smart watch and the mobile phone is lower than the power consumption of the smart watch monitoring the paging message. Therefore, the power consumed by the smart watch due to the monitoring of the paging message can be reduced. In this way, the paging message is monitored and received by the first communication device with a larger battery capacity, and the second communication device receives the paging message through the second-type network, the power consumed by the second communication device monitoring the paging message in the first-type network can be reduced so as to prolong the standby time of the second communication device.

In an example, the step 201 may include: receiving the paging message in the first-type network, and the paging message carries a paging identity of the second communication device.

Here, the paging message sent to the second communication device may be directly monitored by the first communication device in the first-type network.

The first communication device and the second communication device, when establishing a second-type network connection between them, may make an agreement that the paging message is monitored by the first communication device, and the second communication device does not monitor the paging message.

The core network and the like of the first-type network may not change the paging message, and carry the paging identity of an object to which the paging message is intended to be sent in the paging message.

After monitoring the paging message, the first communication device can determine the paging identity contained in the paging message. If the paging identity of the paging message is the paging identity of the second communication device, then the paging message is determined as a paging message to be sent to the second communication device. The first communication device may send the paging message to the second communication device through the second-type network.

Here, the paging identity may be a user equipment identity of the second communication device in the cellular mobile network, or the like.

In an example, the step 201 may include: receiving the paging message carrying both a paging identity of the first communication device and a paging identity of the second communication device in the first-type network.

The base station may carry both the paging identity of the first communication device and the paging identity of the second communication device in the paging message.

In some examples of the present disclosure, the paging information can have a two-layer structure. The paging identity of the first communication device can be set in an outer layer to indicate a monitoring reception object of the paging message, and the paging identity of the second communication device can be set in paging content of an inner layer to indicate a communication device to which the paging content contained in the paging message belongs. The two paging identities in the paging information can also arranged in sequence, the preceding one is used to indicate the monitoring reception object of the paging message, and the subsequent one is used to indicate the communication device to which the paging content contained in the paging message belongs.

After monitoring the paging message, the first communication device can determine the paging identity contained in the paging message. If the paging identity of the paging message is the paging identity of the first communication device, the first communication device can further analyze the content carried in the paging message. If the paging content carried in the paging message is to page the first communication device, the first communication device performs processing according to the paging content. If the paging content carried in the paging message includes the paging identity of the second communication device, the first communication device can send the paging message to the second communication device through the second-type network, and the second communication device can operate based on the paging message.

In this way, the base station determines that the reception object of the paging messages sent to the first communication device and the second communication device is the first communication device, and the first communication device receives all the paging messages, which can reduce the power consumed by the second communication device monitoring the paging message in the first-type network and prolong the standby time of the second communication device.

In an example, before the acquiring the paging message sent by the first-type network to the second communication device, the paging method further includes:

receiving the paging identity of the second communication device through the second-type network.

The second communication device may send its own paging identity in the first-type network to the first communication device through the second-type network.

The first communication device may determine the paging message to be sent to the second communication device according to the received paging identity of the second communication device.

In an example, the paging message includes a UE ID of the first communication device in the first-type network.

Here, the UE ID can uniquely identify the first communication device in the first-type network. When the paging message includes the UE ID of the first communication device, the paging message can be uniquely identified as a paging message sent to the first communication device. Here, the UE ID may include: an International Mobile Subscriber Identity (IMSI), a Serving-Temporary Mobile Subscriber Identity (S-TMSI) or the like.

In an example, before the acquiring the paging message sent by the first-type network to the second communication device, the paging method further includes: receiving a paging binding configuration sent by the second communication device through the second-type network.

The acquiring the paging message sent by the first-type network to the second communication device includes: receiving the paging message sent by the first-type network to the second communication device according to the paging binding configuration.

After the first communication device and the second communication device establish a connection through the second-type network, the second communication device sends the paging binding configuration through the second-type network.

The paging binding configuration may instruct the first communication device to receive the paging message to be sent to the second communication device.

After receiving the paging binding configuration, the first communication device starts to monitor the paging message to be sent to the second communication device. The second communication device can stop monitoring the paging message of the second communication device, or prolong a period of monitoring the paging message, so as to reduce the consumption of battery power and prolong the standby time.

In an example, before the acquiring the paging message sent by the first-type network to the second communication device, the paging method further includes:

sending binding registration information to a core network of the first-type network through a base station of the first-type network, and the binding registration information is used to instruct the core network to send the paging message of the second communication device to the first communication device.

After receiving the paging binding configuration, the first communication device may, according to the paging binding configuration, register in the core network of the first-type network in a registering manner, that the paging message of the second communication device is received by the first communication device. Alternatively, according to a preset setting, when the first communication device establishes the second-type network connection with the second communication device, the first communication device registers in the core network of the first-type network that the paging message of the second communication device is received by the first communication device.

The core network may send the paging message intended to be sent to the second communication device to the first communication device through the base station based on the binding registration information.

In an example, the binding registration information is used to instruct the core network to carry the paging identity of the first communication device and the paging identity of the second communication device in the paging message.

Here, a form of sending the paging message is provided to the core network by the binding registration information. The core network may be instructed to carry both the paging identity of the first communication device and the paging identity of the second communication device in the paging message. The first communication device receives the paging message based on the paging identity of the first communication device when monitoring the paging message, and sends the paging message to the second communication device when the received paging message includes the paging identity of the second communication device.

The second communication device may access the first-type network or perform communication service data transmission and the like based on the paging message sent by the first communication device through the second-type network.

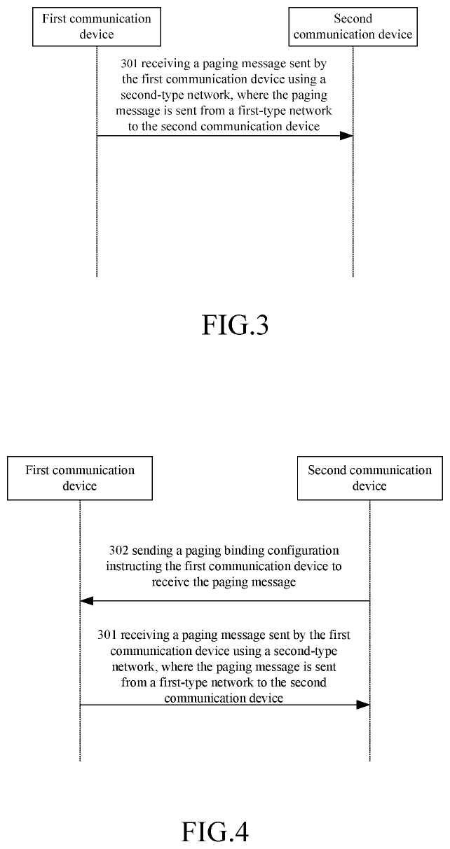

As shown in FIG. 3, the examples of the present disclosure provide a paging method, which is applied to a second communication device. The paging method includes:

in step 301, a paging message sent by a first communication device using a second-type network is received, where the paging message is sent from a first-type network to the second communication device.

The first communication device may be a communication device with a larger battery capacity or a larger amount of remaining power. The second communication device may be a communication device with a smaller battery capacity or a less amount of remaining power.

In some examples of the present disclosure, the first communication device may be a mobile phone or the like with a larger amount of power. The second communication device may be a wearable device such as a smart watch, a sports bracelet, or the like, or the mobile phone with less remaining power.

The first-type network and the second-type network may be networks with different communication protocols, different communication frequency bands, and/or different power ranges.

The first-type network may be a wireless communication network with a larger coverage, and a wireless signal of the first-type network has a larger transmit power.

The second-type network may be a wireless communication network with a smaller coverage, and a wireless signal of the second-type network has a smaller transmit power.

In some examples of the present disclosure, the first-type network may be a cellular mobile communication network such as 4G or 5G. The second-type network may be a short range communication network such as a BlueTooth (BT) network, a low-power consumption BT network, or a Wireless Fidelity (Wi-Fi) network.

Both the first communication device and the second communication device may have capabilities of accessing the first-type network and the second-type network. Both the first communication device and the second communication device can access the first-type network, and the first communication device and the second communication device are connected through the second-type network. In some examples of the present disclosure, the smart watch and the mobile phone can access the 4G cellular mobile communication network, and the smart watch and the mobile phone are connected through the low-power consumption Bluetooth.

The second communication device may be a device in an idle state or a non-active state in the first-type network. When the second communication device is in the idle state or the non-active state, a core network or an access network of the first-type network can wake up (activate) the second communication device by sending the paging message or the like. The base station may send the paging message to the second communication device to instruct the second communication device to initiate a connection with the base station and perform communication. The paging message may include configuration information used by the second communication device to access the first-type network, and the like. The configuration information may include: paging area information, paging reason information, active information, and the like.

Continuously monitoring the paging message by the second communication device will consume power and affect the standby time of the second communication device. The wearable device such as the smart watch, the bracelet and the like carries the relatively small battery capacity due to volume limitations, and the continuous monitoring of the paging messages has a greater impact on the standby time of the wearable device.

Here, a network end of the first-type network may send the paging message intended to be sent to the second communication device to the first communication device. The second communication device no longer monitors the paging message sent by the network end of the first-type network. The paging message sent by the network end of the first-type network to the second communication device is monitored by the first communication device.

After monitoring the paging message sent by the network end of the first-type network to the second communication device, the first communication device can send the paging message to the second communication device through the second-type network. The power consumption of the second-type network between the first communication device and the second communication device is lower than the power consumption of the second communication device monitoring the paging information. Therefore, the power consumed by the second communication device due to the measurement of the wireless signal can be reduced.

In some examples of the present disclosure, the mobile phone and the smart watch are taken as an example. The mobile phone and the smart watch are connected to the base station through a cellular mobile network, and the mobile phone and the smart watch are connected through Bluetooth. When the smart watch is in the idle state or the non-active state in the cellular mobile network, the mobile phone monitors the paging message for the smart watch. When the base station sends the paging message for the smart watch, the mobile phone monitors the paging message for the smart watch, and sends the received paging message intended to be sent to the smart watch, to the smart watch through the Bluetooth connection. The power consumption of the Bluetooth connection between the smart watch and the mobile phone is lower than the power consumption of the smart watch monitoring the paging message. Therefore, the power consumed by the smart watch due to the monitoring of the paging message can be reduced. In this way, the paging message is monitored and received by the first communication device with a larger battery capacity, and the second communication device receives the paging message through the second-type network, the power consumed by the second communication device monitoring the paging message in the first-type network can be reduced so as to prolong the standby time of the second communication device.

In an example, as shown in FIG. 4, before the step 301, the paging method further includes:

in step 302, a paging binding configuration instructing the first communication device to receive the paging message is sent; and

the paging binding configuration is used to instruct the first communication device to receive the paging message sent by the first-type network to the second communication device.

After the first communication device and the second communication device establish a connection through the second-type network, the second communication device sends the paging binding configuration through the second-type network.

The paging binding configuration may instruct the first communication device to receive the paging message to be sent to the second communication device.

After receiving the paging binding configuration, the first communication device starts to monitor the paging message to be sent to the second communication device. The second communication device can stop monitoring the paging message of the second communication device, or prolong a period of monitoring the paging message, so as to reduce the consumption of battery power and prolong the standby time.

In an example, the sending the paging binding configuration instructing the first communication device to receive the paging message includes:

sending a paging identity of the second communication device in the first-type network to the first communication device through the second-type network.

The second communication device may send its own paging identity in the first-type network to the first communication device through the second-type network.

The first communication device may determine the paging message to be sent to the second communication device according to the received paging identity of the second communication device.

In an example, the paging message includes a UE ID of the first communication device in the first-type network.

Here, the UE ID can uniquely identify the first communication device in the first-type network. When the paging message includes the UE ID of the first communication device, the paging message can be uniquely identified as a paging message sent to the first communication device. Here, the UE ID may include an IMSI, an S-TMSI or the like.

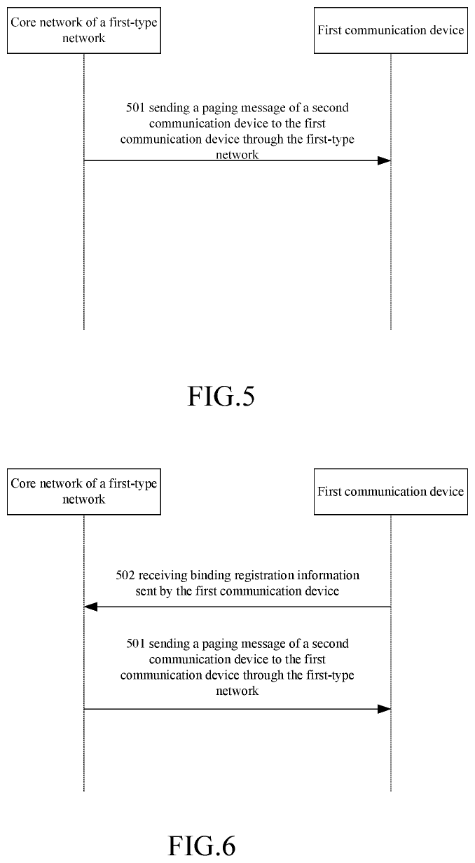

As shown in FIG. 5, the examples of the present disclosure provide a paging method, which is applied to a core network of a first-type network. The paging method includes:

in step 501, a paging message of a second communication device is sent to a first communication device through the first-type network.

The first communication device may be a communication device with a larger battery capacity or a larger amount of remaining power. The second communication device may be a communication device with a smaller battery capacity or a less amount of remaining power.

In some examples of the present disclosure, the first communication device may be a mobile phone or the like with a larger amount of power. The second communication device may be a wearable device such as a smart watch, a sports bracelet, or the like, or the mobile phone with less remaining power.

The first-type network and the second-type network may be networks with different communication protocols, different communication frequency bands, and/or different power ranges.

The first-type network may be a wireless communication network with a larger coverage, and a wireless signal of the first-type network has a larger transmit power.

The second-type network may be a wireless communication network with a smaller coverage, and a wireless signal of the second-type network has a smaller transmit power.

In some examples of the present disclosure, the first-type network may be a cellular mobile communication network such as 4G or 5G. The second-type network may be a short range communication network such as a BlueTooth (BT) network, a low-power consumption BT network, or a Wireless Fidelity (Wi-Fi) network.

Both the first communication device and the second communication device may have capabilities of accessing the first-type network and the second-type network. Both the first communication device and the second communication device can access the first-type network, and the first communication device and the second communication device are connected through the second-type network. In some examples of the present disclosure, the smart watch and the mobile phone can access the 4G cellular mobile communication network, and the smart watch and the mobile phone are connected through the low-power consumption Bluetooth.

The second communication device may be a device in an idle state or a non-active state in the first-type network. When the second communication device is in the idle state or the non-active state, the core network of the first-type network can wake up or activate the second communication device by sending the paging message or the like via the base station. The base station may send the paging message to the second communication device to instruct the second communication device to initiate a connection with the base station and perform communication. The paging message may include configuration information used by the second communication device to access the first-type network, and the like. The configuration information may include: paging area information, paging reason information, and the like.

Continuously monitoring the paging message by the second communication device will consume power and affect the standby time of the second communication device. The wearable device such as the smart watch, the bracelet and the like carries the relatively small battery capacity due to volume limitations, and the continuous monitoring of the paging messages has a greater impact on the standby time of the wearable device.

Here, a network end of the first-type network may send the paging message intended to be sent to the second communication device to the first communication device. The second communication device no longer monitors the paging message sent by the network end of the first-type network. The paging message sent by the network end of the first-type network to the second communication device is monitored by the first communication device.

After monitoring the paging message sent by the network end of the first-type network to the second communication device, the first communication device can send the paging message to the second communication device through the second-type network. The power consumption of the second-type network between the first communication device and the second communication device is lower than the power consumption of the second communication device monitoring the paging information. Therefore, the power consumed by the second communication device due to the measurement of the wireless signal can be reduced.

In some examples of the present disclosure, the mobile phone and the smart watch are taken as an example. The mobile phone and the smart watch are connected to the base station through a cellular mobile network, and the mobile phone and the smart watch are connected through Bluetooth. When the smart watch is in the idle state or the non-active state in the cellular mobile network, the mobile phone monitors the paging message for the smart watch. When the base station sends the paging message for the smart watch, the mobile phone monitors the paging message for the smart watch, and sends the received paging message intended to be sent to the smart watch, to the smart watch through the Bluetooth connection. The power consumption of the Bluetooth connection between the smart watch and the mobile phone is lower than the power consumption of the smart watch monitoring the paging message. Therefore, the power consumed by the smart watch due to the monitoring of the paging message can be reduced.

In this way, the paging message is monitored and received by the first communication device with a larger battery capacity, and the second communication device receives the paging message through the second-type network, the power consumed by the second communication device monitoring the paging message in the first-type network can be reduced so as to prolong the standby time of the second communication device.

In an example, as shown in FIG. 6, before the step 501, the paging method further includes:

in step 502, binding registration information sent by the first communication device is received; and

the step 501 may include: sending the paging message of the second communication device to the first communication device through the first-type network based on instruction of the binding registration information.

After receiving the paging binding configuration, the first communication device may, according to the paging binding configuration, register in the core network of the first-type network in a registering manner, that the paging message of the second communication device is received by the first communication device. Alternatively, according to a preset setting, when the first communication device establishes the second-type network connection with the second communication device, the first communication device registers in the core network of the first-type network that the paging message of the second communication device is received by the first communication device.

The core network may send the paging message intended to be sent to the second communication device to the first communication device through the base station based on the binding registration information.

In an example, the step 501 includes:

sending the paging message carrying both a paging identity of the first communication device and a paging identity of the second communication device through the first-type network.

Here, a form of sending the paging message is provided to the core network by the binding registration information. The core network may be instructed to carry both the paging identity of the first communication device and the paging identity of the second communication device in the paging message. The first communication device receives the paging message based on the paging identity of the first communication device when monitoring the paging message, and sends the paging message to the second communication device when the received paging message includes the paging identity of the second communication device.

The second communication device may access the first-type network or perform communication service data transmission and the like based on the paging message sent by the first communication device through the second-type network.

A specific example is provided below in conjunction with any of the above-mentioned examples:

This example provides specific steps for receiving, by a mobile phone, a paging message of a wearable device A connected to the mobile phone.

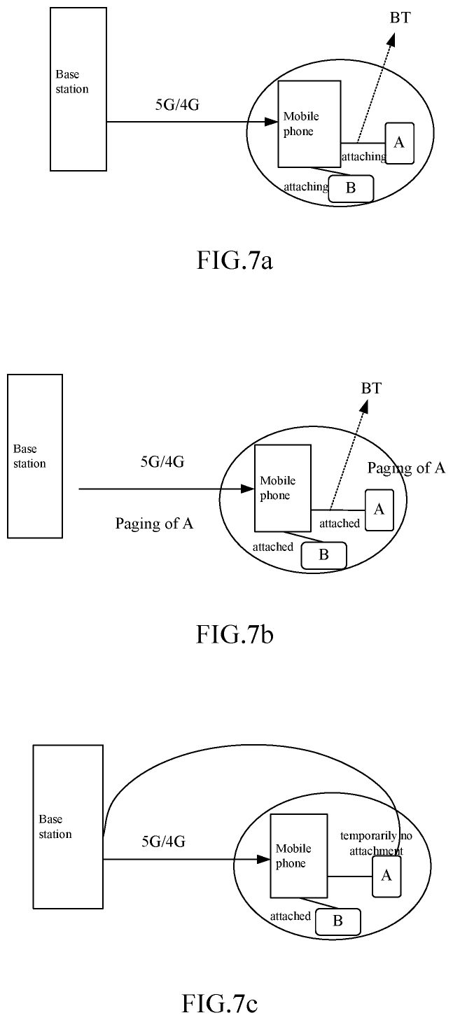

As shown in FIG. 7a, the mobile phone is connected to the wearable device A through Bluetooth, the mobile phone can also be connected to a wearable device B through Bluetooth, and the mobile phone and the wearable device A can be connected to the base station through 4G or 5G cellular mobile communication technologies. The mobile phone can acquire Subscriber Identity Modula (SIM) information of the wearable device A by means of authorization or the like, and the SIM information can include the International Mobile Subscriber Identity (IMSI) and the like.

After the wearable device A is connected to the mobile phone, the wearable device A can first perform an attachment operation. Here, the attachment operation may mean that the wearable device A instructs the mobile phone to monitor the paging message for the wearable device A by means of an instruction or the like.

As shown in FIG. 7b, the wearable device A and the mobile phone complete the attachment operation, and the mobile phone monitors the paging message for the wearable device A. When the mobile phone monitors the paging message for the wearable device A, it sends the paging message for the wearable device A to the wearable device A through the Bluetooth connection.

As shown in FIG. 7c, the wearable device A establishes a connection with the base station according to the paging message received through the Bluetooth connection, and suspends the attachment to the mobile phone, that is, the monitoring of the paging message for the wearable device A by the mobile phone is suspended.

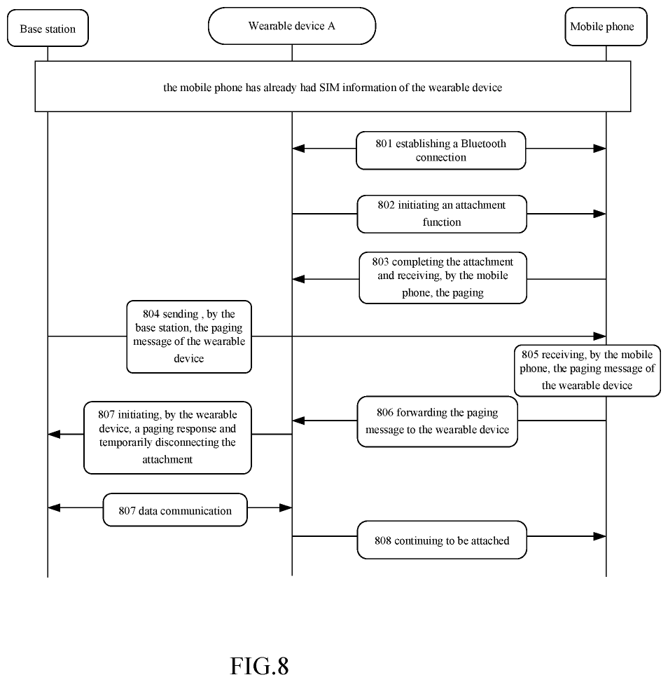

Information interaction between the base station, the mobile phone and the wearable device A is shown in FIG. 8, and includes:

in step 801, a Bluetooth connection is established between the mobile phone and the wearable device A;

in step 802, the mobile phone and the wearable device A perform an attachment operation to instruct the mobile phone to monitor a paging message for the wearable device A;

in step 803, the mobile phone monitors the paging message for the wearable device A;

in step 804, the base station sends the paging message for the wearable device A;

in step 805, the mobile phone receives the paging message for the wearable device A;

in step 806, the mobile phone sends the paging message to the wearable device A through the Bluetooth connection;

in step 807, the wearable device A is connected to the base station and performs data communication based on the paging message; and

in step 808, after the data communication ends, the mobile phone continues to be attached by the wearable device A, and the mobile phone monitors the paging message for the wearable device A.

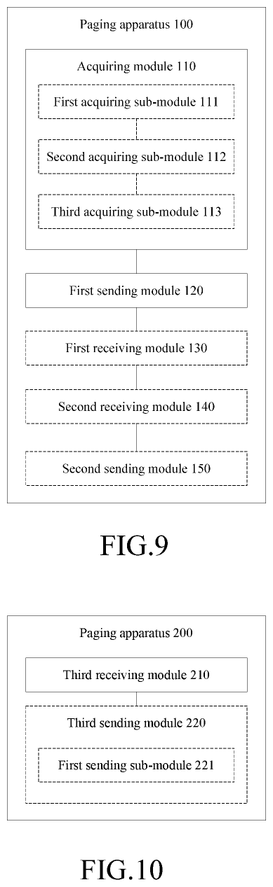

The examples of the present disclosure further provide a paging apparatus, applied to a first communication device. FIG. 9 is a schematic structural diagram of a paging apparatus 100 provided by an example of the present disclosure, and as shown in FIG. 9, the apparatus 100 includes: an acquiring module 110 and a first sending module 120.

The acquiring module 110 is configured to acquire a paging message sent by a first-type network to a second communication device; and

the first sending module 120 is configured to send the paging message to the second communication device through a second-type network.

In an example, the acquiring module 110 includes:

a first acquiring sub-module 111, configured to receive the paging message in the first-type network, wherein a paging identity of the second communication device is carried by the paging message.

In an example, the acquiring module 110 includes:

a second acquiring sub-module 112, configured to receive the paging message in the first-type network, wherein both a paging identity of the first communication device and a paging identity of the second communication device are carried by the paging message.

In an example, the apparatus 110 further includes:

a first receiving module 130, configured to, before the acquiring the paging message sent by the first-type network to the second communication device, receive the paging identity of the second communication device through the second-type network.

In an embodiment, the paging message includes: a UE ID of the first communication device in the first-type network.

In an example, the apparatus 110 further includes:

a second receiving module 140, configured to, before the acquiring the paging message sent by the first-type network to the second communication device, receive a paging binding configuration sent by the second communication device through the second-type network; and

the acquiring module 110 includes:

a third acquiring sub-module 113, configured to receive the paging message sent by the first-type network to the second communication device according to the paging binding configuration.

In an example, the apparatus 100 further includes: a second sending module 150, configured to, before the acquiring the paging message sent by the first-type network to the second communication device, send binding registration information to a core network of the first-type network through a base station of the first-type network, wherein the binding registration information is used to instruct the core network to send the paging message of the second communication device to the first communication device.

In an example, the binding registration information is used to instruct the core network to carry a paging identity of the first communication device and a paging identity of the second communication device in the paging message.

The examples of the present disclosure further provide a paging apparatus, which is applied to a second communication device. FIG. 10 is a schematic structural diagram of a paging apparatus 200 provided by an example of the present disclosure, and as shown in FIG. 10, the apparatus 200 includes: a third receiving module 210.

The third receiving module 210 is configured to receive a paging message sent by a first communication device using a second-type network, where the paging message is sent from a first-type network to the second communication device.

In an example, the apparatus 200 further includes: a third sending module 220, configured to, before the receiving the paging message sent by the first communication device using the second-type network, where the paging message is sent from the first-type network to the second communication device, send a paging binding configuration instructing the first communication device to receive the paging message; and

the paging binding configuration is used to instruct the first communication device to receive the paging message sent by the first-type network to the second communication device.

In an example, the third sending module 220 includes:

a first sending sub-module 221, configured to send a paging identity of the second communication device in the first-type network to the first communication device through the second-type network.

In an example, the paging message includes: a UE ID of the first communication device in the first-type network.

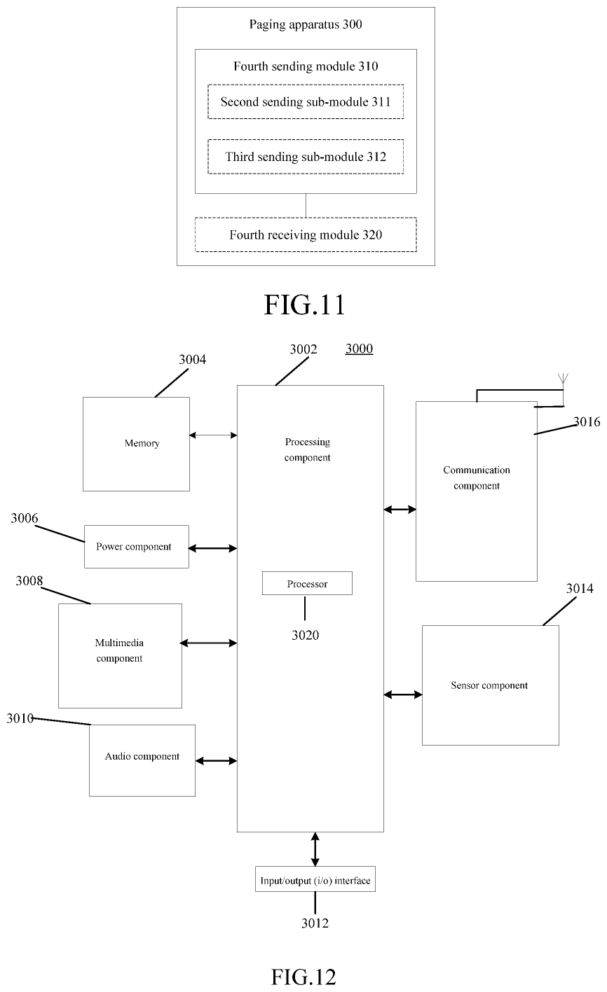

The examples of the present disclosure further provide a paging apparatus, which is applied to a core network of a first-type network. FIG. 11 is a schematic structural diagram of a paging apparatus 300 provided by an example of the present disclosure, and as shown in FIG. 11, the apparatus 300 includes: the fourth sending module 310.

The fourth sending module 310 is configured to send a paging message of a second communication device to a first communication device through the first-type network.

In an example, the apparatus 300 further includes:

a fourth receiving module 320, configured to, before the sending the paging message of the second communication device to the first communication device through the first-type network, receive binding registration information sent by the first communication device; and

the fourth sending module 310 includes:

a second sending sub-module 311, configured to send the paging message of the second communication device to the first communication device through the first-type network based on instruction of the binding registration information.

In an example, the fourth sending module 310 includes:

a third sending sub-module 312, configured to send the paging message carrying both a paging identity of the first communication device and a paging identity of the second communication device through the first-type network.

In an example, the acquiring module 110, the first sending module 120, the first receiving module 130, the second receiving module 140, the second sending module 150, the third receiving module 210, the third sending module 220, the fourth sending module 310 and the fourth receiving module 320 and the like may be implemented with one or more Central Processing Units (CPUs), Graphics Processing Units (GPUs), Baseband Processors (BPs), Application Specific Integrated Circuits (ASICs), Digital Signal Processors (DSPs), Programmable Logic Devices (PLDs), Complex Programmable Logic Devices (CPLDs), Field-Programmable Gate Arrays (FPGAs), general-purpose processors, controllers, Micro Controller Units (MCUs), microprocessors or other electronic components, or may be implemented by incorporating one or more Radio Frequency (RF) antennas, and configured to perform the above method.

FIG. 12 is a block diagram showing a device 3000 for paging according to an example of the present disclosure. For example, the device 3000 may be a mobile phone, a computer, a digital broadcast terminal, a messaging apparatus, a gaming console, a tablet, a medical apparatus, exercise equipment, a personal digital assistant, etc.

Referring to FIG. 12, the device 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls overall operations of the device 3000, such as the operations associated with display, telephone calls, data communications, camera operations, and recording operations. The processing component 3002 may include one or more processors 3020 to execute instructions to perform all or part of the steps in the above described methods. Moreover, the processing component 3002 may include one or more modules which facilitate the interaction between the processing component 3002 and other components. For instance, the processing component 3002 may include a multimedia module to facilitate the interaction between the multimedia component 3008 and the processing component 3002.

The memory 3004 is configured to store various types of data to support the operation of the device 3000. Examples of such data include instructions for any applications or methods operated on the device 3000, contact data, phonebook data, messages, pictures, video, etc. The memory 3004 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3006 provides power to various components of the device 3000. The power component 3006 may include a power management system, one or more power sources, and any other components associated with the generation, management, and distribution of power in the device 3000.

The multimedia component 3008 includes a screen providing an output interface between the device 3000 and the user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some examples, the multimedia component 3008 includes a front camera and/or a rear camera. The front camera and the rear camera may receive an external multimedia datum while the device 3000 is in an operation mode, such as a photographing mode or a video mode. Each of the front camera and the rear camera may be a fixed optical lens system or have focus and optical zoom capability.

The audio component 3010 is configured to output and/or input audio signals. For example, the audio component 3010 includes a microphone (MIC) configured to receive an external audio signal when the device 3000 is in an operation mode, such as a call mode, a recording mode, and a voice recognition mode. The received audio signal may be further stored in the memory 3004 or transmitted via the communication component 3016. In some examples, the audio component 3010 further includes a speaker to output audio signals.

The I/O interface 3012 provides an interface between the processing component 3002 and peripheral interface modules, such as a keyboard, a click wheel, buttons, and the like. The buttons may include, but are not limited to, a home button, a volume button, a starting button, and a locking button.

The sensor component 3014 includes one or more sensors to provide status assessments of various aspects of the device 3000. For instance, the sensor component 3014 may detect an open/closed status of the device 3000, relative positioning of components, e.g., the display and the keypad, of the device 3000, a change in position of the device 3000 or a component of the device 3000, a presence or absence of user contact with the device 3000, an orientation or an acceleration/deceleration of the device 3000, and a change in temperature of the device 3000. The sensor component 3014 may include a proximity sensor configured to detect the presence of nearby objects without any physical contact. The sensor component 3014 may also include a light sensor, such as a CMOS or CCD image sensor, for use in imaging applications. In some examples, the sensor component 3014 may also include an accelerometer sensor, a gyroscope sensor, a magnetic sensor, a pressure sensor, or a temperature sensor.

The communication component 3016 is configured to facilitate communication, wired or wirelessly, between the device 3000 and other apparatus. The device 3000 may access a wireless network based on a communication standard, such as WiFi, 2G, or 3G, or a combination thereof. In an example, the communication component 3016 receives a broadcast signal or broadcast associated information from an external broadcast management system via a broadcast channel. In an example, the communication component 3016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the device 3000 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above described methods.

In an example, there is also provided a non-transitory computer readable storage medium including instructions, such as the memory 3004 including instructions, the above instructions may be executed by the processor 3020 in the device 3000 for performing the above-described methods. For example, the non-transitory computer-readable storage medium may be a ROM, a Random Access Memory (RAM), a CD-ROM, a magnetic tape, a floppy disc, an optical data storage device, and the like.

Other examples of the present disclosure will be apparent to those skilled in the art from consideration of the specification and practice of the present disclosure disclosed here. The present disclosure is intended to cover any variations, uses, or adaptations of the examples of the present disclosure following the general principles thereof and including the common general knowledge or habitual technical means in the technical field not disclosed in the examples of the present disclosure. The specification and examples are considered as exemplary only, and a true scope and spirit of the examples of the present disclosure is indicated by the appending claims.

It will be appreciated that the examples of the present disclosure is not limited to the exact construction that has been described above and illustrated in the accompanying drawings, and that various modifications and changes may be made without departing from the scope thereof. It is intended that the scope of the examples of the present disclosure only be limited by the appended claims.

The examples of the present disclosure provide a paging method and apparatus, a communication device, and a storage medium.

According to a first aspect of the examples of the present disclosure, there is provided a paging method, applied to a first communication device, and the method includes:

acquiring a paging message sent by a first-type network to a second communication device; and

sending the paging message to the second communication device through a second-type network.

In an example, the acquiring the paging message sent by the first-type network to the second communication device includes:

receiving the paging message in the first-type network, wherein a paging identity of the second communication device is carried by the paging message.

In an example, the acquiring the paging message sent by the first-type network to the second communication device includes:

receiving the paging message in the first-type network, wherein both a paging identity of the first communication device and a paging identity of the second communication device are carried by the paging message.

In an example, before the acquiring the paging message sent by the first-type network to the second communication device, the method further includes:

receiving a paging identity of the second communication device through the second-type network.

In an example, the paging message includes: a User Equipment Identity (UE ID) of the first communication device in the first-type network.

In an example, before the acquiring the paging message sent by the first-type network to the second communication device, the method further includes:

receiving a paging binding configuration sent by the second communication device through the second-type network;

the acquiring the paging message sent by the first-type network to the second communication device includes:

receiving the paging message sent by the first-type network to the second communication device according to the paging binding configuration.

In an example, before the acquiring the paging message sent by the first-type network to the second communication device, the method further includes:

sending binding registration information to a core network of the first-type network through a base station of the first-type network, wherein the binding registration information is used to instruct the core network to send the paging message of the second communication device to the first communication device.

In an example, the binding registration information is used to instruct the core network to carry the paging identity of the first communication device and the paging identity of the second communication device in the paging message.

According to a second aspect of the examples of the present disclosure, there is provided a paging method, applied to a second communication device, and the method includes:

receiving a paging message sent by a first communication device using a second-type network, wherein the paging message is sent from a first-type network to the second communication device.

In an example, before the receiving the paging message sent by the first communication device using the second-type network, wherein the paging message is sent from the first-type network to the second communication device, the method further includes:

sending a paging binding configuration instructing the first communication device to receive the paging message; and

wherein the paging binding configuration is used to instruct the first communication device to receive the paging message sent by the first-type network to the second communication device.

In an example, the sending the paging binding configuration instructing the first communication device to receive the paging message includes:

sending a paging identity of the second communication device in the first-type network to the first communication device through the second-type network.

In an example, the paging message includes: a UE ID of the first communication device in the first-type network.

According to a third aspect of the examples of the present disclosure, there is provided a paging method, applied to a core network of a first-type network, and the method includes:

sending a paging message of a second communication device to a first communication device through the first-type network.

In an example, before the sending the paging message of the second communication device to the first communication device through the first-type network, the method further includes:

receiving binding registration information sent by the first communication device;

the sending the paging message of the second communication device to the first communication device through the first-type network includes:

sending the paging message of the second communication device to the first communication device through the first-type network based on instruction of the binding registration information.

In an example, the sending the paging message of the second communication device to the first communication device through the first-type network includes:

sending the paging message carrying a paging identity of the first communication device and a paging identity of the second communication device through the first-type network.

According to a fourth aspect of the examples of the present disclosure, there is provided a paging apparatus, applied to a first communication device, and the apparatus includes an acquiring module and a first sending module, wherein,

the acquiring module is configured to acquire a paging message sent by a first-type network to a second communication device; and

the first sending module is configured to send the paging message to the second communication device through a second-type network.

In an example, the acquiring module includes:

a first acquiring sub-module, configured to receive the paging message in the first-type network, wherein a paging identity of the second communication device is carried by the paging message.

In an example, the acquiring module includes:

a second acquiring sub-module, configured to receive the paging message in the first-type network, wherein both a paging identity of the first communication device and a paging identity of the second communication device are carried by the paging message.

In an example, the apparatus further includes:

a first receiving module, configured to, before the acquiring the paging message sent by the first-type network to the second communication device, receive a paging identity of the second communication device through the second-type network.

In an example, the paging message includes: a UE ID of the first communication device in the first-type network.

In an example, the apparatus further includes:

a second receiving module, configured to, before the acquiring the paging message sent by the first-type network to the second communication device, receive a paging binding configuration sent by the second communication device through the second-type network;

the acquiring module includes:

a third acquiring sub-module, configured to receive the paging message sent by the first-type network to the second communication device according to the paging binding configuration.

In an example, the apparatus further includes: a second sending module, configured to, before the acquiring the paging message sent by the first-type network to the second communication device, send binding registration information to a core network of the first-type network through a base station of the first-type network, wherein the binding registration information is used to instruct the core network to send the paging message of the second communication device to the first communication device.

In an example, the binding registration information is used to instruct the core network to carry the paging identity of the first communication device and the paging identity of the second communication device in the paging message.

According to a fifth aspect of the examples of the present disclosure, there is provided a paging apparatus, applied to a second communication device, and the apparatus includes a third receiving module, wherein:

the third receiving module is configured to receive a paging message sent by a first communication device using a second-type network, wherein the paging message is sent from a first-type network to the second communication device.

In an example, the apparatus further includes: a third sending module, configured to, before the receiving the paging message sent by the first communication device using the second-type network, wherein the paging message is sent from the first-type network to the second communication device, send a paging binding configuration instructing the first communication device to receive the paging message; and

wherein the paging binding configuration is used to instruct the first communication device to receive the paging message sent by the first-type network to the second communication device.

In an example, the third sending module includes:

a first sending sub-module, configured to send a paging identity of the second communication device in the first-type network to the first communication device through the second-type network.

In an example, the paging message includes: a UE ID of the first communication device in the first-type network.

According to a sixth aspect of the examples of the present disclosure, there is provided a paging apparatus, applied to a core network of a first-type network, and the apparatus includes a fourth sending module, wherein:

the fourth sending module is configured to send a paging message of a second communication device to a first communication device through the first-type network.

In an example, the apparatus further includes:

a fourth receiving module, configured to, before the sending the paging message of the second communication device to the first communication device through the first-type network, receive binding registration information sent by the first communication device;

the fourth sending module includes:

a second sending sub-module, configured to send the paging message of the second communication device to the first communication device through the first-type network based on instruction of the binding registration information.

In an example, the fourth sending module includes:

a third sending sub-module, configured to send the paging message carrying a paging identity of the first communication device and a paging identity of the second communication device through the first-type network.

According to a seventh aspect of the examples of the present disclosure, there is provided a communication device including a processor, a transceiver, a memory, and an executable program stored on the memory and capable of being run by the processor, wherein the processor executes steps of the paging method described in the first aspect or the second aspect or the third aspect when running the executable program.

According to an eighth aspect of the examples of the present disclosure, there is provided a storage medium on which an executable program is stored, wherein the executable program, when executed by a processor, implements steps of the paging method described in the first aspect or the second aspect or the third aspect when running the executable program.

1. A paging method, comprising:
acquiring, by a first communication device, a paging message sent by a first-type network to a second communication device; and
sending, by the first communication device, the paging message to the second communication device through a second-type network.

2. The method according to claim 1, wherein acquiring the paging message sent by the first-type network to the second communication device comprises:
receiving the paging message in the first-type network, wherein the paging message comprises a paging identity of the second communication device.

3. The method according to claim 1, wherein acquiring the paging message sent by the first-type network to the second communication device comprises:
receiving the paging message in the first-type network, wherein the paging message comprises both a paging identity of the first communication device and a paging identity of the second communication device.

4. The method according to claim 2, wherein before acquiring the paging message sent by the first-type network to the second communication device, the method further comprises:
receiving the paging identity of the second communication device through the second-type network.

5. The method according to claim 4, wherein the paging message comprises a User Equipment Identity (UE ID) of the first communication device in the first-type network.

6. The method according to claim 1, wherein before acquiring the paging message sent by the first-type network to the second communication device, the method further comprises:
receiving a paging binding configuration sent by the second communication device through the second-type network; and
wherein acquiring the paging message sent by the first-type network to the second communication device comprises:
receiving the paging message sent by the first-type network to the second communication device according to the paging binding configuration.

7. The method according to claim 1, wherein before acquiring the paging message sent by the first-type network to the second communication device, the method further comprises:
sending binding registration information to a core network of the first-type network through a base station of the first-type network, wherein the binding registration information is configured to instruct the core network to send the paging message of the second communication device to the first communication device.

8. The method according to claim 7, wherein the binding registration information is configured to instruct the core network to carry a paging identity of the first communication device and a paging identity of the second communication device in the paging message.

9. A paging method, comprising:
receiving, by a second communication device, a paging message sent by a first communication device using a second-type network, wherein the paging message is sent from a first-type network to the second communication device.

10. The method according to claim 9, wherein before receiving the paging message sent by the first communication device using the second-type network, wherein the paging message is sent from the first-type network to the second communication device, the method further comprises:
sending a paging binding configuration instructing the first communication device to receive the paging message; and
wherein the paging binding configuration is configured to instruct the first communication device to receive the paging message sent by the first-type network to the second communication device.

11. The method according to claim 10, wherein sending the paging binding configuration instructing the first communication device to receive the paging message comprises:
sending a paging identity of the second communication device in the first-type network to the first communication device through the second-type network.

12. The method according to claim 11, wherein the paging message comprises: a User Equipment Identity (UE ID) of the first communication device in the first-type network.

13. A paging method, comprising:
sending, by a core network of a first-type network, a paging message of a second communication device to a first communication device through the first-type network.

14. The method according to claim 13, wherein before sending the paging message of the second communication device to the first communication device through the first-type network, the method further comprises:
receiving binding registration information sent by the first communication device; and
wherein sending the paging message of the second communication device to the first communication device through the first-type network comprises:
sending the paging message of the second communication device to the first communication device through the first-type network based on instruction of the binding registration information.

15. The method according to claim 13, wherein sending the paging message of the second communication device to the first communication device through the first-type network comprises:
sending the paging message carrying both a paging identity of the first communication device and a paging identity of the second communication device through the first-type network.

16. A first communication device, comprising:
a processor;
a transceiver; and
a memory, configured to store an executable program of the processor,
wherein the processor is configured to execute the executable program to implement the paging method according to claim 1.

17. The first communication device according to claim 16, wherein the processor is further configured to:
receive the paging message in the first-type network, wherein the paging message comprises a paging identity of the second communication device.

18. The first communication device according to claim 16, wherein the processor is further configured to:
receive the paging message in the first-type network, wherein the paging message comprises both a paging identity of the first communication device and a paging identity of the second communication device.

19. The first communication device according to claim 17, wherein the processor is further configured to:
before acquiring the paging message sent by the first-type network to the second communication device, receive the paging identity of the second communication device through the second-type network.

20. The first communication device according to claim 19, wherein the paging message comprises: a User Equipment Identity (UE ID) of the first communication device in the first-type network.

21-32. (canceled)
